(19) United States
(12) Patent Application Publication
(10) Pub. No.: US 2013/0217488 A1
(43) Pub. Date: Aug. 22, 2013

(54) AUGMENTED REALITY SYSTEM

(71) Applicant: Radu Mircea COMSA, Bucharest (RO)

(72) Inventor: Radu Mircea COMSA, Bucharest (RO)

(21) Appl. No.: 13/772,911

(22) Filed: Feb. 21, 2013

Related U.S. Application Data
(60) Provisional application No. 61/601,545, filed on Feb. 21, 2012.

(51) Int. Cl. G06F 17/00

(52) U.S. Cl. CPC G06F 17/00
USPC 463/31; 463/42; 463/39; 463/36; 463/35

(57) ABSTRACT

An augmented reality system that includes a local representative equipment, a system control equipment and remote actor equipment. The local representative equipment captures audio and image data, as sensed data, in an activity area of an avatar player, the remote control unit receives a command data from a remote participant, and the system control equipment, in response to an enablement command, enables transmission of the sensed data from the local representative equipment to the remote actor equipment, and enables transmission of command data from the remote actor equipment to the local representative equipment. Moreover, the local representative equipment outputs the command data to the avatar player through the local interface unit and the remote control unit communicates the sensed data to the remote participant through the sensed data output unit.

### CROSS-REFERENCE TO RELATED APPLICATION

The present invention claims priority from U.S. Provisional Patent Application No. 61/601,545 filed Feb. 21, 2012, the disclosure of which is incorporated herein in its entirety by reference.

### BACKGROUND

1. Field

The current disclosure relates to augmented reality systems, and particularly to avatar players in augmented reality systems.

2. Background

An augmented reality system helps bridge the real and the cyber worlds. Related art augmented reality systems ignore individual and system dimensionality by splitting the universe of interest in two, the borderline being the difference between making a decision and applying it, as shown in FIG. 1. For instance, E1 is a first environment where the decision is made (DM-decision making process) and E2 is a second environment where the decision is applied (DA-decision application process).

Both environments (E1 and E2) and processes (DM and DA) can be either real or virtual. For simplicity, the cases where the decision making process is always “real” (i.e., decision is made by a human brain) is discussed below.

FIG. 2 illustrates eight cases in which the decision making process is real. Case 1 reflects the real world, where the two environments coincide. An example of this case is a casino player playing at Bellagio in Vegas.

In case 2, everything is real, but the decision making environment does not coincide as a physical space with the decision application. This case may be referred to as “avatar reality” or “translated reality” as the decision made in environment E1 is applied in environment E2 via an avatar of the decision maker, the avatar being real or virtual. This case also helps to logically translate all other cases, so the distinction E1=E2 or E1≠E2 is not repeated for the subsequent cases.

An example of case 3 is SMARTLIVE CASINO, which involves real roulette with a real croupier (E2=real). Players from around the world place (DA=virtual) a variety of online bets.

An example of case 4 is the NINTENDO WII game console, where a bowling arena is virtual (E2=virtual), but the decision application is real (DA=real) and made by manipulations of the player's own limbs.

An example of case 5 is online games, such as WORLD OF WARCRAFT, SUPER MARIO, or online poker, where the E1 is real and E2 is virtual.

An example of case 6 is a method in which special glasses (E1=virtual) are used to show how to repair a specific problem on a car, or to train mechanics, showing them the correct sequence of operations.

An example of case 7 is video game (i.e., a NINTENDO WII game) played with 3D glasses.

An example of case 8 is a roulette concept created by the Vienna University of Technology, Institute of Computer Graphics. This concept involves using head-mounted displays and special computer tablets, all played by real players.

The real casino offers live experience, which is the main advantage of the real casino over any virtually enhanced format. While the industry investors are convinced of the experience diversification benefits, they are also fully aware of the quality of the experience required by their premium and super-premium customers. The live experience is extremely carefully set up for them, from hiring the best interior designers to imposing the toughest dress-code. Moreover, dedication of the service and the ambience is equally important to the premium and super-premium customers, from valet parking and personal reception/assistance by top level senior stay, to stratospheric clubs prices. Also, the premium and super-premium customers want the best privacy and discretion given by the same very exclusive clubs prices and best trained staff.

With the exception of privacy, which is automatically given by the virtual quality of anonymity for all cases from 2 to 8, as virtual grows to a greater proportion, the quality of the experience and the dedication ability decrease. Also the universal accessibility of the virtual is exactly what a premium customer highly dislikes.

As described above, the SMARTLIVE CASINO corresponds to the case no 3 format, which is the closest to the real world (real casino) one can play today. The real croupiers and real roulette tables (placed somewhere in UK) make the difference in experience with all other cases. However, the conventional virtual casino systems, like the SMARTLIVE CASINO, lack live experience and dedication of the service demanded by the premium and super-premium customers. The following exemplary scenarios describe the needs of a premium and super-premium casino player.

For instance, Person M. is a celebrity or person of notoriety who has a private life that may be exposed on the dirtiest tabloids and paparazzi are keen to get pictures of one of his other pleasures—gambling. M. likes the most sophisticated casinos with a reasonably tempered addiction, making him a regular visitor of them, never spending more than a self-imposed limit. However, the amount of the usual self-imposed limit makes him a premium customer. M. had to refrain from gambling a long time and was really upset by the lack of the exquisite mix of live experience and some addiction.

Person S. is, for example, an oil company executive, who excused himself the last evening dinner citing health problems. His colleagues amused themselves to reveal he was visiting the most exclusive casino in the city in view of an upcoming three weeks trip to a very strict Middle East country where gambling is forbidden.

There are many other reasons preventing premium customers to fulfill their desire of spending a night at the favorite Casino, from post-surgery (air) travel restrictions to political exposure.

Despite having fully guaranteed privacy, a very low percentage of the premium and super-premium customers play online gaming formats, which they consider not only commonplace, but also as not really matching their desire, because the conventional online gaming formats lack experience and dedication.

### SUMMARY

One or more embodiments of the disclosure relate to an augmented reality system that provides experience and dedication of service by implementing avatar reality or translated reality, such that the decision made in environment E1 is applied in environment E2 via an avatar of the decision maker, the avatar being real or virtual.

According to an embodiment, there is provided an augmented reality system that includes a local representative equipment, a system control equipment and remote actor equipment. The local representative equipment includes one or more information sensor units configured to output sensed data, a local interface unit configured to interface with an avatar player, a local communication unit, and a local control unit configured to control the one or more sensor units and the local communication unit.

According to the embodiment, the system control equipment includes a supervisory interface unit, a downstream communication unit in communication with the local communication unit, an upstream communication unit, a system control unit controlling the upstream communication unit, the downstream communication unit and the supervisory interface unit.

According to the embodiment, the remote actor equipment includes a sensed data output unit configured to output the sensed data, a remote interface unit configured to input downstream command data from the remote participant, a remote communication unit in communication with the upstream communication unit and a remote control unit configured to control the sensed data output unit, the remote interface input unit, and the remote communication unit.

The supervisory interface unit, in response to an enablement command: forwards a downstream enablement signal to the local representative equipment via the downstream communication unit, forwards an upstream enablement signal to the remote actor equipment via the upstream communication unit, enables transmission of the sensed data, received at the downstream communication unit, to the upstream communication unit and enables transmission of the command data, received at the upstream communication unit, to the downstream communication unit.

The local control unit responds to the downstream enablement signal by: controlling the local communication unit to communicate the sensed data upstream, to the downstream communication unit and providing the downstream command data to the local interface unit.

The remote control unit responds to the upstream enablement signal by: controlling the remote communication unit to communicate the downstream command data downstream, to the upstream communication unit; and controlling the remote communication unit to communicate the sensed data upstream to the sensed data output unit.

According to another embodiment, there is provided a method for facilitating an augmented reality system having a local representative equipment located in activity area, a remote actor equipment located at a remote area, and a system control equipment configured to control communication between the local representative equipment and the remote actor equipment. According to the method, the system control equipment receives an enablement command by an supervisory interface of the system control equipment, forwards the enablement command to the local representative equipment and the remote actor equipment, receives sensed data from the local representative equipment, receives command data from the remote actor equipment, transmits the sensed data to the remote actor equipment; and transmits the command data to the local representative equipment.

In this embodiment, the local control unit senses information about the environment in the activity area, transmits the sensed data to the system control equipment based on the sensing information, receives the command data from the system control equipment and outputs.

According to this embodiment, the remote actor equipment receives the command data from a remote participant at the remote area, transmits the command data to the system control equipment, receives the sensed data from the system control equipment and outputs the sensed data.

According to another embodiment, there is provided a computer readable medium having stored thereon a method for facilitating an augmented reality system having a local representative equipment located in activity area, a remote actor equipment located at a remote area, and a system control equipment configured to control communication between the local representative equipment and the remote actor equipment. According to the method, the system control equipment receives an enablement command by an supervisory interface of the system control equipment, forwards the enablement command to the local representative equipment and the remote actor equipment, receives sensed data from the local representative equipment, receives command data from the remote actor equipment, transmits the sensed data to the remote actor equipment; and transmits the command data to the local representative equipment.

In this embodiment, the local control unit senses information about the environment in the activity area, transmits the sensed data to the system control equipment based on the sensing information, receives the command data from the system control equipment and outputs.

According to this embodiment, the remote actor equipment receives the command data from a remote participant at the remote area, transmits the command data to the system control equipment, receives the sensed data from the system control equipment and outputs the sensed data.

### DRAWINGS

FIG. 1 is an illustration that depicts a split universe analysis framework.

FIG. 2 is an illustration that depicts a number of cases that are possible under the analysis framework shown in FIG. 1.

FIG. 3 depicts an overall view of an augmented reality system according to one exemplary embodiment.

FIG. 4 depicts an activity area aspect of an augmented reality system according to one exemplary embodiment.

FIG. 5 depicts avatar player equipment of an augmented reality system according to one exemplary embodiment.

FIG. 6 depicts an avatar player wearing the avatar player equipment of an augmented reality system according to exemplary embodiment.

FIGS. 7 and 8 depict various details of the avatar player equipment of an augmented reality system according to other exemplary embodiments.

FIG. 9 depicts coordination hub control equipment of an augmented reality system according to one exemplary embodiment.

FIG. 10 depicts various details of the avatar player equipment of an augmented reality system according to other exemplary embodiments.

FIG. 11 depicts remote area and remote participant equipment of an augmented reality system according to one exemplary embodiment.

FIG. 12 depicts a feedback unit of the avatar player equipment of an augmented reality system according to an exemplary embodiment.

FIG. 13 depicts a feedback unit of the avatar player equipment of an augmented reality system according to another exemplary embodiment.

FIG. 14 depicts an overview of an exemplary embodiment of an augmented reality system.

FIG. 15 depicts an overview of another exemplary embodiment of an augmented reality system.

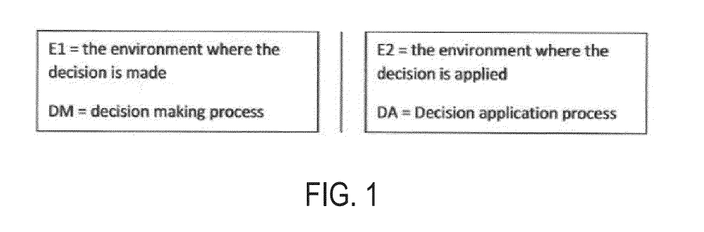

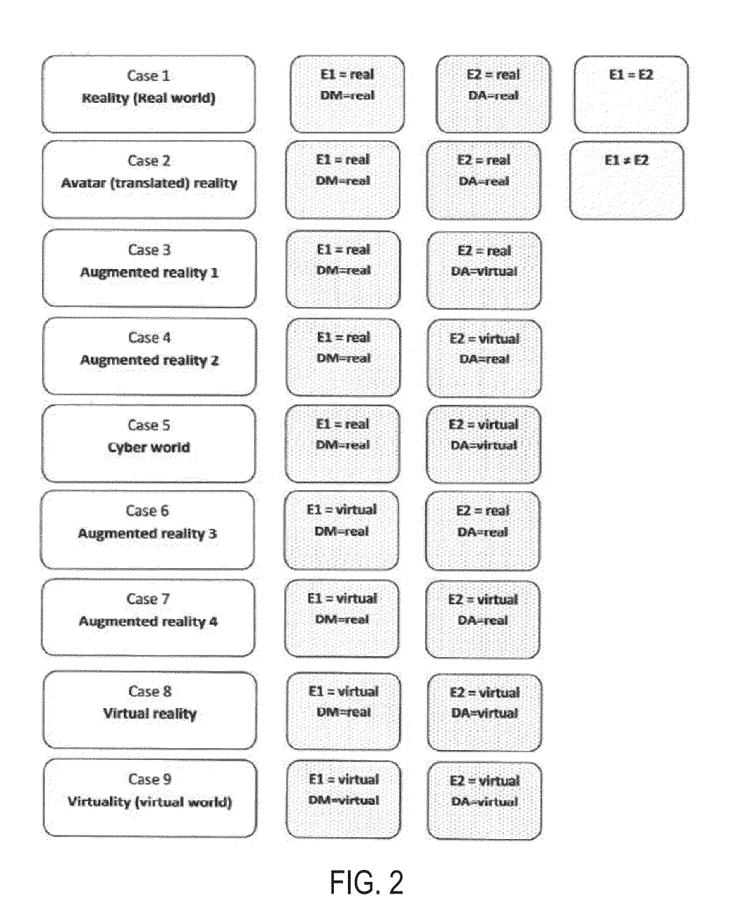

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein, and equivalent modifications. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

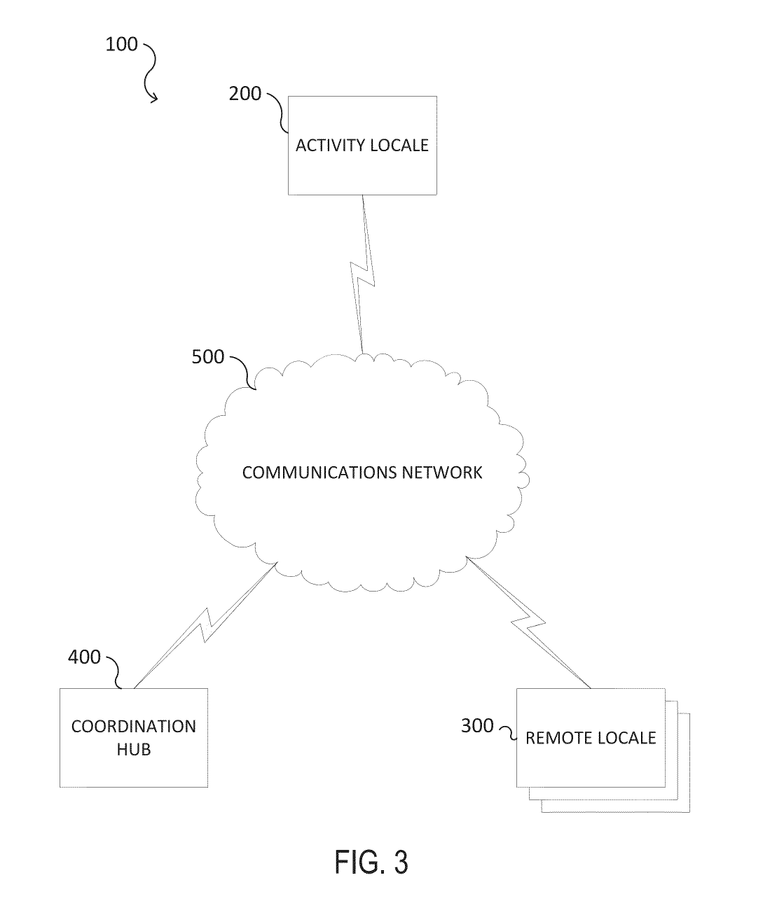

FIG. 3 illustrates an embodiment of the augmented reality system realized as an augmented reality casino gaming system. The augmented reality casino gaming system 100 includes an activity locale 200, which is a real casino, a remote locale 300 where one or more remote participants (i.e., real players) are located, and a coordination hub 400, which controls and monitors the communication between the activity locale 200 and the remote locale 300 through the communication network 500.

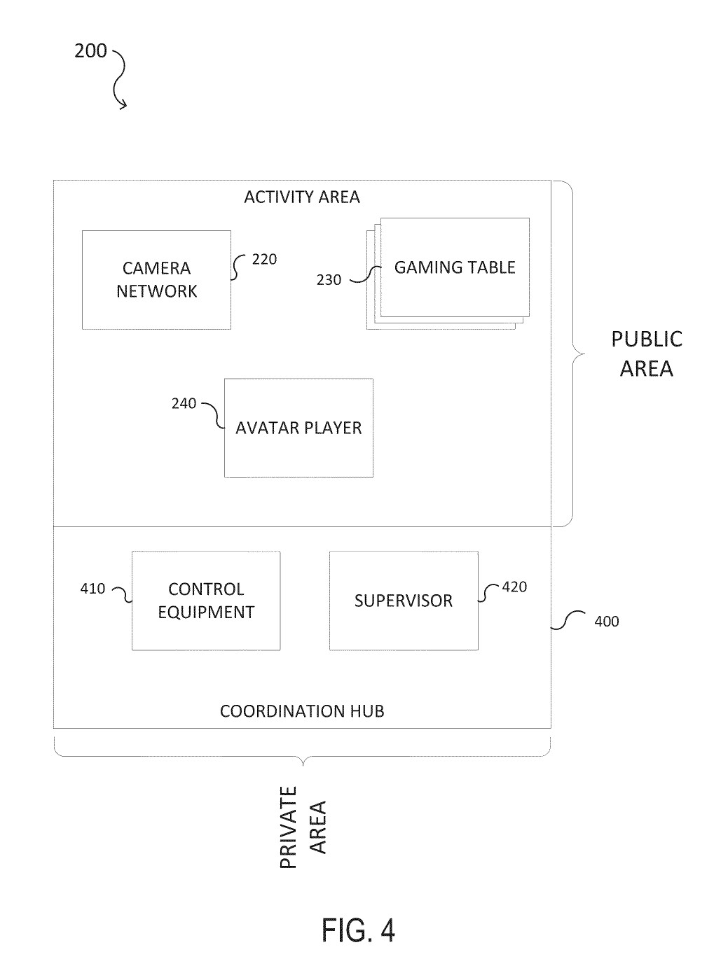

As shown in FIG. 4, the activity locale 200 includes an activity area where casino games are carried out by the casino. In an embodiment, the activity area includes table games 230 such as card games, roulette, etc. The activity area may also include computerized games such as slot machines. In the embodiment, one or more network cameras 220 are provided throughout the activity area to capture (hear and see) the activities in the environment. For example, the network camera captures the croupier saying “no more bets”.

In the embodiment, an avatar player (i.e., courtesy player or local representative) 240, represents a remote participant in the real casino environment and performs actions on behalf of the remote participant based on the commands or instructions from the remote participant. The avatar player may be provided by the casino and follows all regulatory gaming laws as enforced by the casino rules.

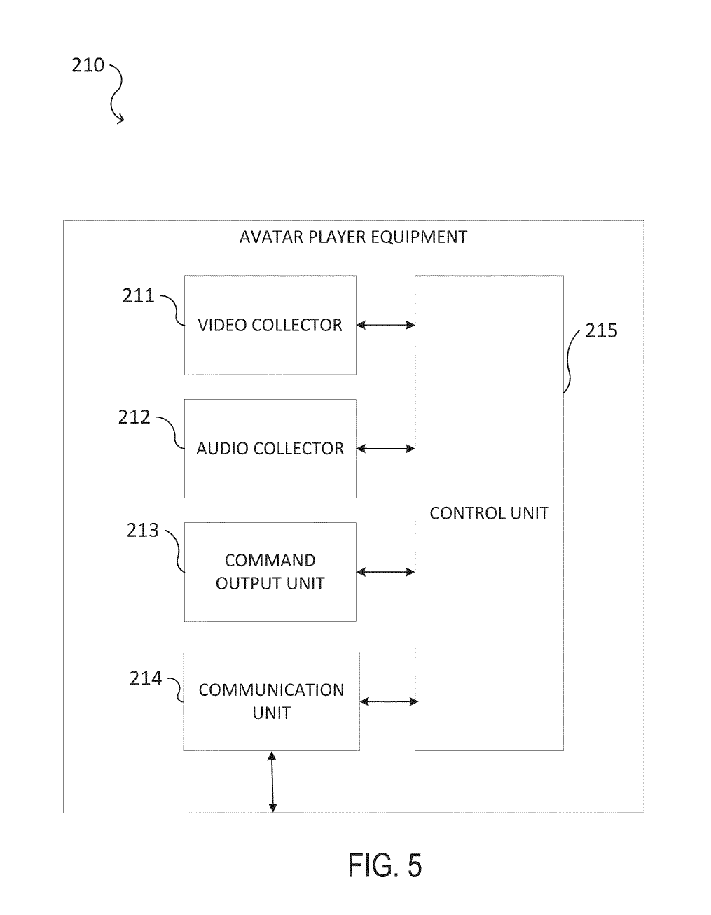

In an embodiment, the avatar player 240 wears an avatar player equipment 210, as shown in FIG. 5, which communicates the environment at the activity locale 200 to the remote participant in the remote locale 300. The avatar player equipment 210 also conveys instructions or commands from the remote participant to the avatar player 240. The avatar player equipment 210 includes a video collector 211, an audio collector 212, a command output unit 213, a communication unit 214 and a control unit 215.

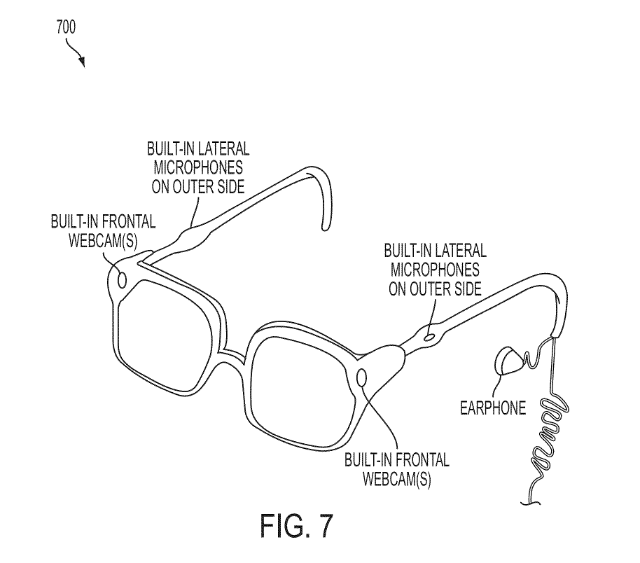

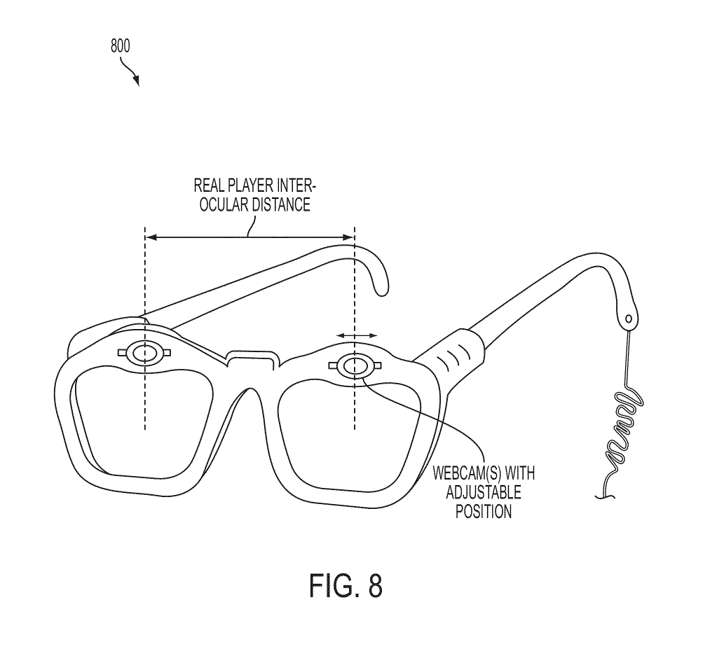

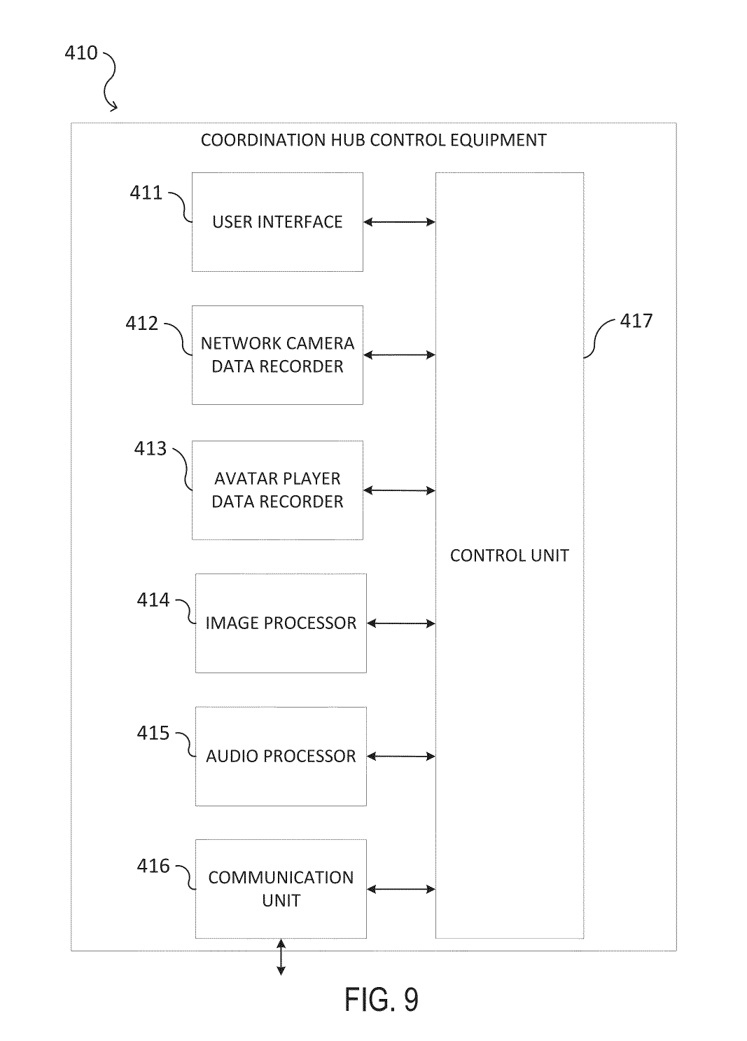

The video collector 211 is an image acquiring device such as a webcam or other cameras. The audio collector 212 is a microphone, in an embodiment. The video collector 211 and the audio collector 212 may be head mounted (i.e., in glasses 700 and 800 shown in FIGS. 7 and 8), tie-mounted, or mounted on any part of the body or article of clothing worn by the avatar player 240.

The command output unit 213 receives commands or instructions from the remote participant and conveys the commands to the avatar player 240, so that the avatar player 240 can perform the appropriate functions requested by the remote participant. The command output unit 213 may be audio devices (i.e., speakers or earphones), video (i.e., display embedding in the glasses) or other devices (led light, vibrating devices, etc.) that can convey the remote participant's commands or instructions to the avatar player.

The control unit 215 controls the video collector 211 and audio collector 212 to receive sensed data (i.e., video and audio data) and transmits the sensed data, via the communication unit 214, to a control equipment 410 in the coordination hub 400. Also, the control unit 215 receives the remote participant's commands from the coordination hub 400 and forwards the commands to the command output unit 213.

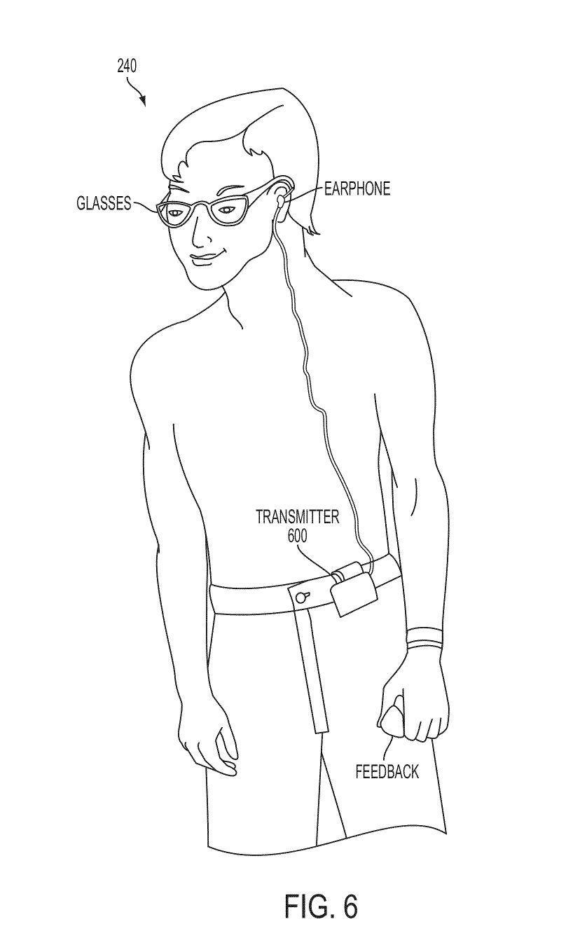

FIG. 6 shows an illustration of the avatar player 240 wearing the avatar player equipment 210 illustrated in FIG. 5. The avatar player 240 may wear the avatar player equipment discreetly. Also, the avatar player equipment 210 may be unidirectionally connected in real time with the remote participant in the manner the remote participant has visual and audio contact with the casino environment in the remote locale 300. The avatar player 240 may be specialized casino staff with appropriate training to carry out the requests of the remote participant. While the avatar player 240 may be visible to the other players, the avatar player 240 carries out the requests from the remote participant in a discrete way without disturbing the typical casino environment.

In an embodiment, while the avatar player 240 walks around the casino according to the request of the remote participant, or plays games where the player's decision does not influence the result like roulette, a heavily secured wireless connection may be used. On the other hand, while the avatar player 240 plays games where the player's decision influences the result (i.e., poker game) a fully wired connection may be used for security reasons.

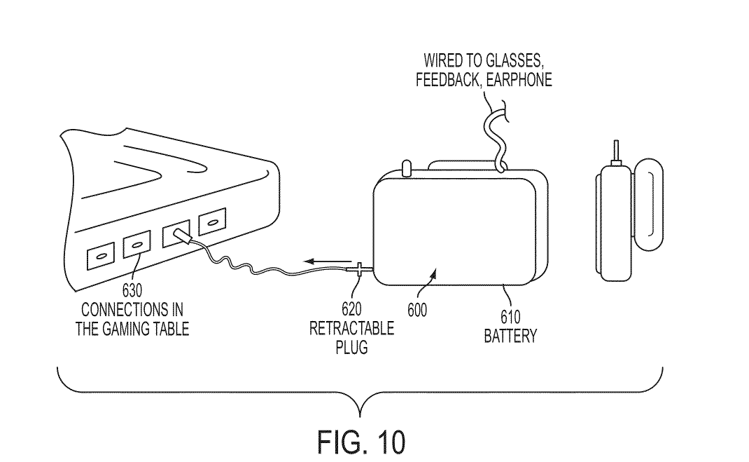

The control unit 215 may include a portable digital signal transmitter 600 as illustrated in FIG. 6 and FIG. 10. The transmitter 600 maybe attached to the avatar player's 240 clothing (or belt) using an attaching mechanism. One way of attaching the transmitter 600 to the avatar player may be using a Velcro. The transmitter 600 includes a portable power source (i.e., battery 610) for the avatar player equipment 210. Also, the transmitter 600 may be provided with an extensible (retractable) plug 620 (FIG. 10) in case a fully secured (wired) data transmission is needed, the plug to be introduced by the avatar player in specially mounted data connectors inserted in the gaming table (or in specific racks). In an embodiment, the transmitter 600 is wired to an earphone, which allows the avatar player 240 to receive verbal playing orders from the remote participant. The earphone can be free or attached to the glasses.

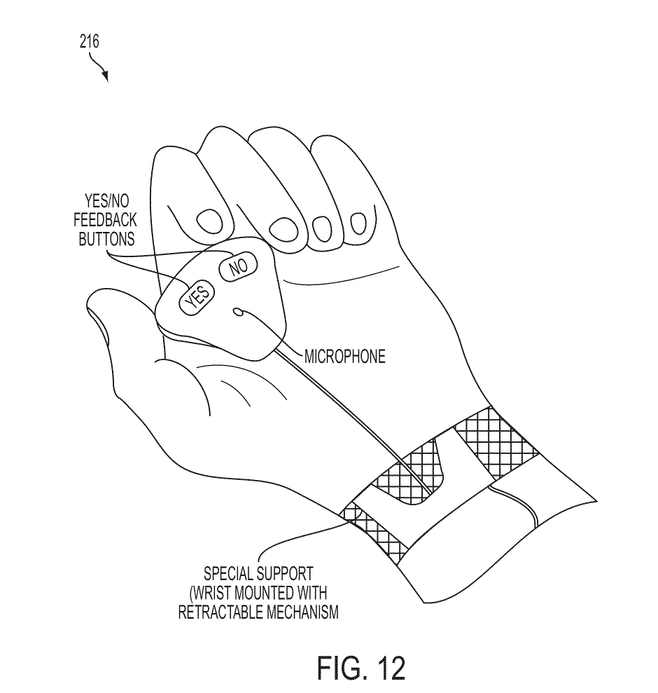

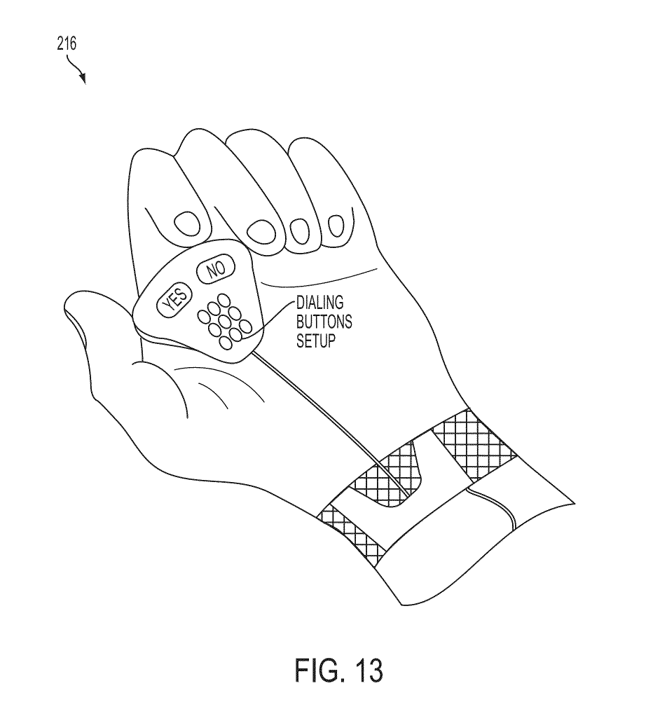

In another embodiment, the avatar player equipment 210 includes a feedback unit 216 shown in FIGS. 12 and 13. For instance, the feedback unit 216 may be implemented, in one exemplary embodiment, as a wrist/palm held device, which allows the avatar player 240 to provide the remote participant 320 with a real time feedback. The feedback unit 216 may include a built-in microphone, which can be enabled by a start-stop button placed on the case of the feedback unit 216. The feedback unit 216 may include one or more push-buttons, which can be pressed by the avatar player 240 to give positive or negative visual feedback on a display screen of the data output unit of a remote participant equipment. This allows the avatar player to give an instant yes/no feedback without the need of starting the microphone. The feedback unit 216 may be retractable in a special support (negative shape) mounted on a bracelet, and thus quickly freeing the avatar player's 240 hand in case both hands are needed for playing.

The feedback unit 216 may further include a palm held microphone feature, which provides a discrete/secure way for the avatar player to give verbal feedback to the real player. The feedback unit 216 may be wirelessly linked to the transmitter 600.

In another embodiment, the feedback unit 216 includes a keyboard or a numeric (0-9) dialing layout, which can be operated by the avatar player to enter available amount (or balance) for playing the casino game to the remote participant. The forwarded amount may be displayed on a display screen of the remote participant equipment.

In another embodiment, the feedback unit 216 includes a touch screen panel, which can be operated by the avatar player to enter a desired input. The feedback unit 216 can also include other types of input devices, which can be operated by the avatar player to enter a desired input.

In another embodiment, the avatar player equipment 210 has a direct communication system, which enables the avatar player 240 to directly communicate with the supervisor 420, separate from the communication channel with the remote participant 320. For instance, through a signal protocol, (e.g. 1 beep=real player wants to end session, 2 beeps=real player wants another static camera view, 3 beeps=emergency etc.), the avatar player 240 signals the supervisor 320 these situations (e.g. the moment the real player wants to end the session and/or eventual emergencies which impose an end of the session).

In an embodiment shown in FIG. 4, a coordination hub 400 (i.e., a control area) includes a control equipment 410 and supervisor 420 provided in a private area of the activity local 200. In another embodiment, the coordination hub 400 is provided in a separate location as shown in FIG. 3. The coordination hub 400 is the casino interface/control between the avatar player 240 and the remote participant 320 (i.e., the real player).

The coordination hub control equipment 410, in an embodiment shown in FIG. 8, includes a user interface 411, a network camera data recorder 412, an avatar player data recorder 413, an image processor 414, an audio processor 415, a communication unit 416, and a control unit 417.

The coordination hub control equipment 410 receives data (image and sound from the activity locale 200) from the avatar player equipment 210 through the communication unit 416. The communication unit can receive the data via a wireless transmission or via a fully secured wired transmission. In the case of the wired transmission, an input/output jack may be inserted in a communication interface provided at the gaming table 630 as shown in FIG. 10. The coordination hub control equipment 410 also receives data from the network camera 220 provided in the activity locale 200.

The control unit 417 controls the network camera data recorder 412 and the avatar player data recorder 413 to record the data received from the network camera 220 and avatar play equipment 210 in storage. Further, the control unit 417 controls the image processor 414 and audio processor 415 to process the image and audio data received from the activity locale. Upon completion of the audio and image processing, the control unit 417 transmits the processed image and audio data to a remote participant equipment 320 at the remote locale 300 via communication unit 416.

In the embodiment, the control unit 417 receives commands from the remote participant 320, processes the commands and transmits the processed commands to the avatar player equipment 210. In an embodiment, the commands may be an audio command (verbal orders) from the remote participant.

In an embodiment, the audio processor 415 includes a filter to modify an audio command from the remote participant. For instance, if the real player, desiring extreme privacy, wants his voice to be modified before reaching the avatar player, the filter may include an acoustic frequency converter that converts and modifies the remote participant's voice.

In an embodiment, the image processor 414 may send a still image from the activity locale 200 to the remote participant. For instance, in a case where the avatar player equipment's video collector abruptly moves fast (i.e., when the avatar player is pushed by others or the equipment falls), the image processor 414 sends the still image so that any disturbance to the remote participant's viewing experience caused by the abrupt movement of the video collection would be removed.

In an embodiment, the control unit 417 is controlled by a third person belonging to the Casino staff (i.e., supervisor) via the user interface 411. For instance, the control unit controls the processing and communication of data received from the activity locale 200 and the remote locale 300 based on an enablement signal entered by the supervisor in the user interface 411. The enablement signal may be entered when a remote participant, who is registered with the casino, desires to and authenticated to use the augmented reality casino gaming system to remotely play the casino games.

The supervisor 420 has a monitor view for each gaming pairs (avatar player/remote participant) active in a session. The supervisor 420 enables or validates the transmission protocol between the avatar player 240 and the remote participant 320 at the beginning of the session (remote participant identity, transmission check from both sides, etc.), to monitor the session and to validate the end of the session following the appropriate signal coming from the courtesy player expressing such desire of the real player, or to validate a sudden transmission cut from the real player. The supervisor 420 may have the ability to interfere or stop the private session between the avatar player 240 and the remote participant 320 in case of an emergency or in case of a fraud suspicion detection by casino staff.

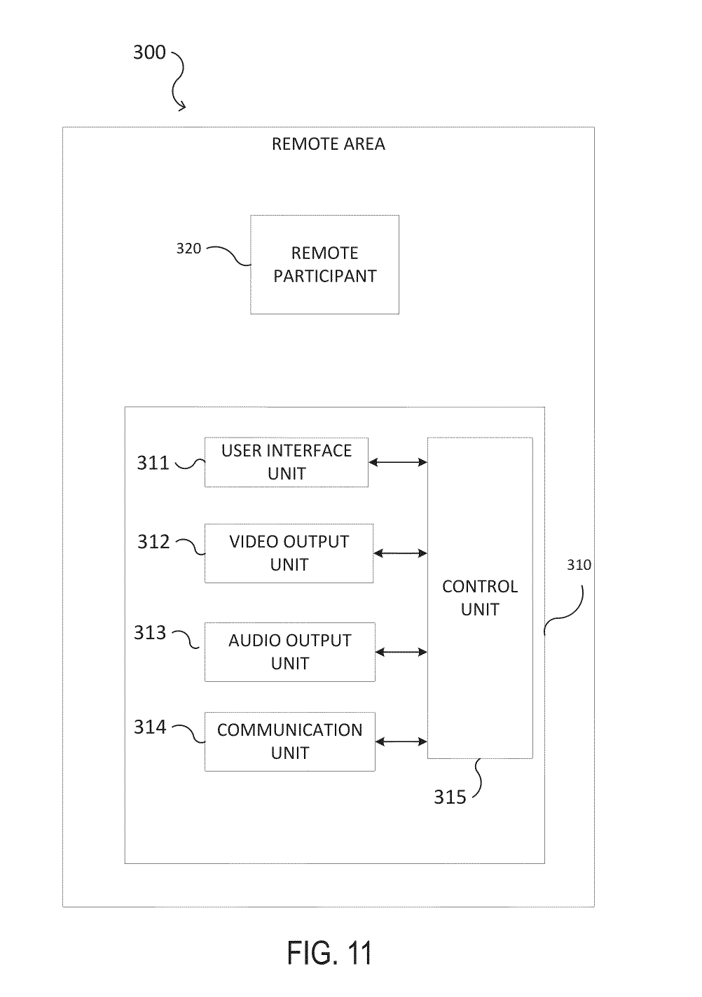

As show in FIG. 11, the remote locale 300 of FIG. 3 is provided with a remote player equipment 310, which enables a remote participant 320 to communicate the avatar player 240 through the coordination hub 400, according an embodiment. The remote player equipment 310 includes a user interface unit 311, a video output unit 312, an audio output unit 313, a communication unit 314 and a control unit 315.

In an embodiment, the control unit 315 receives processed data, which includes image and audio data corresponding to the activity locale's 200 environment, via the communication unit 314 and controls the video and audio output units to output the processed image and audio data.

In the embodiment, the control unit receives commands from the remote participant via the user interface unit 311, processes the commands and transmits the commands to the coordination hub 400 view the communication unit 312. According to an embodiment, the user interface 311 is capable of receiving audio command (verbal orders) from the remote participant.

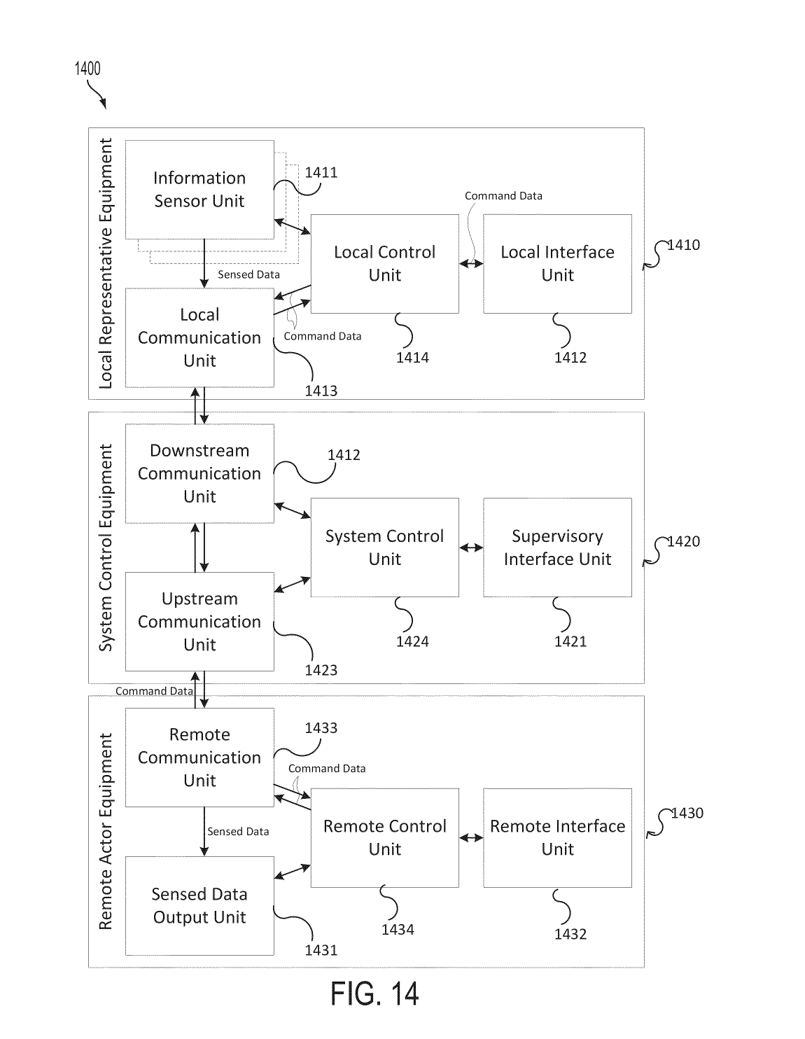

FIG. 14 illustrates an overview of an exemplary embodiment of an augmented reality system 1400. The augmented reality system 1400 includes a local representative equipment 1410 provided in an activity locale 200, a system control equipment 1420 provided at the coordination hub 400 and remote actor equipment 1430 provided at a remote locale 300. The local representative equipment and the coordination hub 400 may be located at a casino offering augmented reality gaming system services. In another embodiment, the coordination hub 400 may be remotely located, at a location different from the casino, to centrally monitor and control session between a plurality of local representative equipments 1410 and a plurality of remote actor equipments 1430, respectively.

In an embodiment, the local representative equipment 1410 includes one or more information sensor units 1411 which captures events and activities in an environment at the activity locale 200, and outputs the results as sensed data. The sensor units 1411 may be a camera, a microphone or both, embedded in a pair of glasses worn by the avatar player 240.

The local representative equipment 1410 further includes a local interface unit 1412 which enables the remote participant 420 at the remote locale 300 to interface with the avatar player 240. For instance, the local interface unit 1412 may be an earphone capable of outputting commands from the remote participant 420.

In this embodiment, the local interface unit 1410 includes a local control unit 1414 which controls control the one or more sensor units 1411 and the local interface unit 1412. The local control unit 1414 maybe a computer processor. Also, the local interface unit 1410 has a local communication unit 1413 which communicates the sensed data to the remote participant and commands from the remote participant.

In this embodiment, the system control equipment 1420 includes a supervisory interface unit 1421, a downstream communication unit 1422 in communication with the local communication unit 1413, an upstream communication unit 1423, and a system control unit 1424 which control the upstream communication unit, the downstream communication unit and the supervisory interface unit.

In this embodiment, the remote actor equipment 1430 includes a sensed data output unit 1431 which outputs the sensed data received from the local representative equipment 1410 through the system control equipment 1420. The sensed data output unit may be a display monitor, a speaker. The remote actor equipment 1430 further includes a remote interface unit 1432 configured to input downstream command data from the remote participant 420. The remote interface unit 1432 may be a microphone or other devices through which the remote participant 420 can enter commands or orders to the avatar player 240.

The remote actor equipment 1420 also includes a remote communication unit 1433 in communication with the upstream communication unit 1423 and a remote control unit 1434 configured to control the sensed data output unit 4131, the remote interface input unit 1432, and the remote communication unit 1433.

The supervisory interface unit 1421, in response to receiving an enablement command from a supervisor (i.e., casino staff), forwards a downstream enablement signal to the local representative equipment 1410 via the downstream communication unit 1422, forwards an upstream enablement signal to the remote actor equipment 1430 via the upstream communication unit 1423, enables transmission of the sensed data, received at the downstream communication unit 1422 from the local communication unit 1413, to the upstream communication unit 1423 and enables transmission of the command data, received at the upstream communication unit 1423 from the remote communication unit 1433, to the downstream communication unit 1422.

The local control unit 1414 responds to the downstream enablement signal by controlling the local communication unit 1413 to communicate the sensed data upstream, to the downstream communication unit 1422 and providing the downstream command data to the local interface unit 1412.

The remote control unit 1434 responds to the upstream enablement signal by controlling the remote communication unit 1433 to communicate the downstream command data downstream, to the upstream communication unit 1423 and controlling the remote communication unit 1433 to communicate the sensed data upstream to the sensed data output unit 1431.

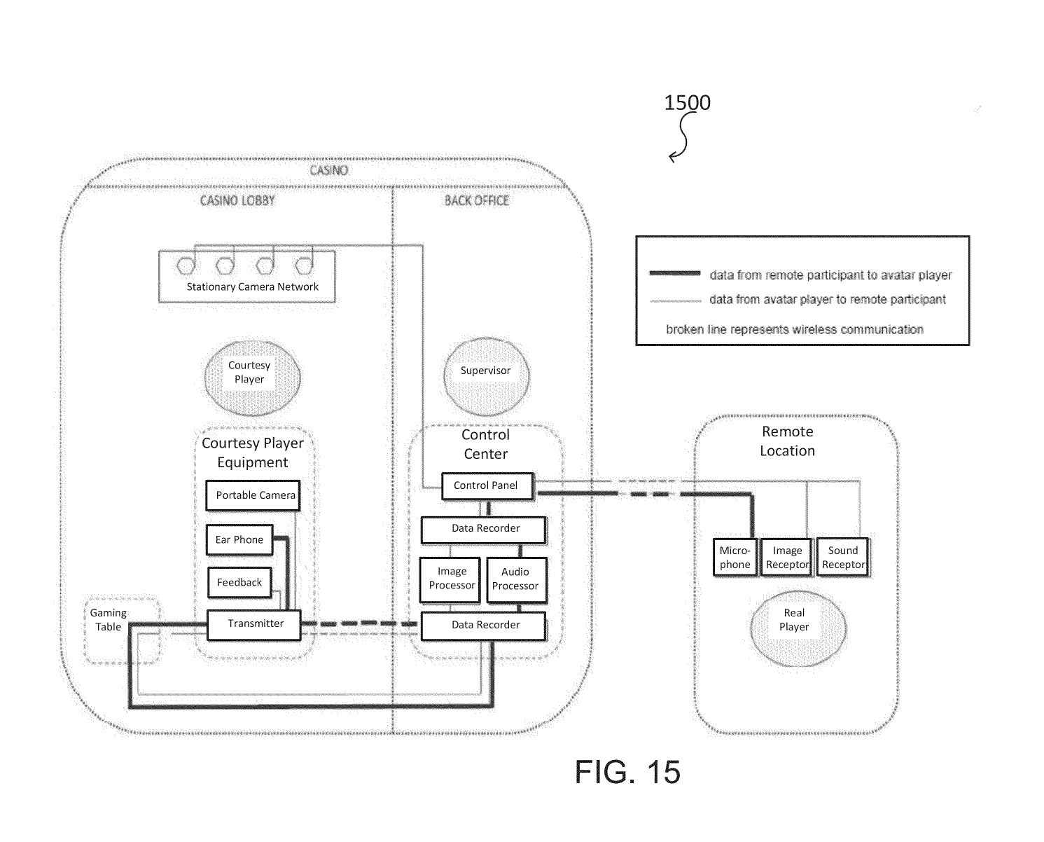

FIG. 15 illustrates an overview of another exemplary embodiment of an augmented reality system 1500 showing the communication of data between the avatar player and the remote participant.

In another embodiment, the coordination hub control equipment includes an account management unit configured to manage the remote participant's 320 gaming account. In an embodiment, the account management unit includes a fee monitoring unit for determining a fee for the service provided by the casino the augmented reality casino gaming system. For instance, the casino makes available the service and trains a crew of specialized courtesy players. The service can be either offered for free for best customers or against a fee (session forfeit or pay per time unit: per hour, per half an hour, per minute etc.).

In another embodiment, the coordination hub includes a registration unit, which register's the remote participant with the casino augmented reality gaming system. In an embodiment, in order to register, the remote participant has to agree to state and casino rules. Some of the rules may include age limit, spending limits, payment mode and details (i.e., credit card, deposit at casino, etc.), agreement that the casino has the right to stop the transmission/service at any moment, and agreement for the digital data to be kept by the casino for a certain period of time, with the remote participant having the ability to make a complaint within that period.

The registration agreement may also include provisions such as the avatar player will execute exactly the orders of the real player and will not interfere in the gaming, the avatar player will only provide feedback to answer remote participant questions, the remote participant can have one and only one avatar player for one gaming session, either reserved or chosen from one available at the moment he wants to play the session.

According to a scenario in an embodiment of the augmented reality casino gaming system, the avatar player 240 starts to walk and play in the gaming tables 230 at the activity area, according to the gaming habits and desire of the remote participant 320.

For example, the remote participant might ask the avatar player to first walk downstairs and start with a slot machine, where the avatar player introduces the coin and pulls the lever at the verbal orders of the remote participant, heard in the command output unit 213 (i.e., earphone) (“again!’, “five more and we go” etc.).

Then the avatar player is ordered by the remote participant to go to a (certain) roulette table and play. The avatar player bets the amount and on the number he is told by the remote participant. In the meantime, the remote participant, via the avatar player's video collector 211 and audio collector 213 hears/sees the environment in the activity area, for example hears the croupier “no more bets” words and behaves accordingly.

The avatar player also has a feedback unit 216 including yes/no push buttons and a handheld microphone. For example, if the remote participant asks “Did I bet split last time?” or “too crowded here, do you spot an emptier table?”, the avatar player 240 will answer by pushing the relevant yes/no button and the answer will appear on the remote participant's display screen of the video output unit 312. If asked questions like “don't remember last two numbers, tell me” the courtesy player will discreetly speak in the handheld microphone, giving the more complex answer (“fourteen and thirty-two”). Pushing both yes/no buttons simultaneously will make appear a question mark on the real player screen, asking him to repeat the question.

A frequent remote participant 320 will develop the skill of playing without the need of much feedback or at least questioning the avatar player in order to be quickly answered by yes/no. For instance, in a blackjack game, the remote participant 320 may see the cards via avatar player video collector 211 and/or the network camera 220, hear the dealer via audio collector 212 and order for example “hit”, which would make the avatar player behave accordingly, by repeating “hit” to the dealer and making appropriate hand signals.

In another embodiment, the real player can contact the supervisor in case of need, via a dedicated phone assistance.

Although the inventive concept has been described above with respect to the various embodiments, it is noted that there can be a variety of permutations and modifications of the described features by those who are familiar with this field, without departing from the technical ideas and scope of the features, which shall be defined by the appended claims.

A method of one or more embodiments may be recorded as computer-readable program codes in non-transitory computer-readable media (CD ROM, random access memory (RAM), read-only memory (ROM), floppy disks, hard disks, magneto-optical disks, and the like) including program instructions to implement various operations embodied by a programmable processor.

While this specification contains many features, the features should not be construed as limitations on the scope of the disclosure or of the appended claims. Certain features described in the context of separate embodiments can also be implemented in combination. Conversely, various features described in the context of a single exemplary embodiment can also be implemented in multiple exemplary embodiments separately or in any suitable subcombination.

There is claimed:

1. An augmented reality system, comprising:
local representative equipment;
system control equipment; and
remote actor equipment;
wherein the local representative equipment comprises:
one or more information sensor units configured to output sensed data;
a local interface unit;
a local communication unit; and
a local control unit controlling the one or more sensor units and the local communication unit;
wherein the system control equipment comprises:
a supervisory interface unit;
a downstream communication unit in communication with the local communication unit;
an upstream communication unit;
a system control unit controlling the upstream communication unit, the downstream communication unit; and the supervisory interface unit;
wherein the remote actor equipment comprises:
a sensed data output unit configured to output the sensed data;
a remote interface unit configured to input downstream command data;
a remote communication unit in communication with the upstream communication unit; and
a remote control unit controlling the sensed data output unit, the remote interface input unit, and the remote communication unit;
wherein the supervisory interface unit, in response to an enablement command:
forwards a downstream enablement signal to the local representative equipment via the downstream communication unit;
forwards an upstream enablement signal to the remote actor equipment via the upstream communication unit;
enables transmission of the sensed data, received at the downstream communication unit, to the upstream communication unit; and
enables transmission of the command data, received at the upstream communication unit, to the downstream communication unit;
wherein the local control unit responds to the downstream enablement signal by:
controlling the local communication unit to communicate the sensed data upstream, to the downstream communication unit; and
providing the downstream command data to the local interface unit;
wherein the remote control unit responds to the upstream enablement signal by:
controlling the remote communication unit to communicate the downstream command data downstream, to the upstream communication unit; and
controlling the remote communication unit to communicate the sensed data upstream to the sensed data output unit.

2. The augmented reality system of claim 1, wherein the local representative equipment comprises a feedback unit configured to provide a feedback message to an inquiry from the remote actor equipment.

3. The augmented reality system of claim 2, wherein the feedback unit includes a microphone, which senses the feedback message.

4. The augmented reality system of claim 2, wherein the feedback unit includes an input unit, which senses the feedback message.

5. The augmented reality system of claim 1, wherein the local representative equipment is wearable by a local representative.

6. The augmented reality system of claim 1, wherein the local representative equipment is located within a casino.

7. The augmented reality system of claim 1, wherein one or more information sensor units is at least one video camera and a microphone.

8. The augmented reality system of claim 1, wherein the local interface unit is an earphone.

9. The augmented reality system of claim 1, the sensed data output unit is at least one of a video display or a speaker.

10. The augmented reality system of claim 1, the remote interface unit is a microphone.

11. A method for facilitating an augmented reality system having a local representative equipment located in activity area, a remote actor equipment located at a remote area, and a system control equipment configured to control communication between the local representative equipment and the remote actor equipment, the method comprising:
at the system control equipment:
receiving an enablement command by an supervisory interface of the system control equipment;
forwarding the enablement command to the local representative equipment and the remote actor equipment;
receiving sensed data from the local representative equipment;
receiving command data from the remote actor equipment;
transmitting the sensed data to the remote actor equipment; and
transmitting the command data to the local representative equipment,
at the local control unit:
sensing information about the environment in the activity area;
transmitting the sensed data to the system control equipment based on the sensing information;
receiving the command data from the system control equipment; and
outputting the command data, and
at the remote actor equipment:
receiving the command data from a remote participant at the remote area;
transmitted the command data to the system control equipment;
receiving the sensed data from the system control equipment; and
outputting the sensed data.

12. The method of claim 11, further comprising:
receiving, at the local representative equipment, an inquiry from the remote participant at the remote actor equipment; and
transmitting a feedback message to the remote actor equipment through the system control equipment.

13. The augmented reality system of claim 11, wherein the local representative equipment is located within a casino.

14. A computer readable medium having stored there on a method for facilitating an augmented reality system having a local representative equipment located in activity area, a remote actor equipment located at a remote area, and a system control equipment configured to control communication between the local representative equipment and the remote actor equipment, the method comprising:
at the system control equipment:
receiving an enablement command by an supervisory interface of the system control equipment;
forwarding the enablement command to the local representative equipment and the remote actor equipment;
receiving sensed data from the local representative equipment;
receiving command data from the remote actor equipment;
transmitting the sensed data to the remote actor equipment; and
transmitting the command data to the local representative equipment,
at the local control unit:
sensing information about the environment in the activity area;
transmitting the sensed data to the system control equipment based on the sensing information;
receiving the command data from the system control equipment; and
outputting the command data, and
at the remote actor equipment:
receiving the command data from a remote participant at the remote area;
transmitting the command data to the system control equipment;
receiving the sensed data from the system control equipment; and
outputting the sensed data.

15. The computer readable medium of claim 14, further comprising:
receiving, at the local representative equipment, an inquiry from the remote participant at the remote actor equipment; and
transmitting a feedback message to the remote actor equipment through the system control equipment.
